(19) United States
(12) Patent Application Publication
(10) Pub. No.: US 2011/0041661 A1
(43) Pub. Date: Feb. 24, 2011

(54) Rotary Cutting Tool, Method of Cutting Billet for Manufacturing Seamless Pipe or Tube, and Method of Manufacturing Seamless Pipe or Tube

(75) Inventors: Yasuhiro Kouchi, Osaka (JP); Osamu Kanda, Osaka (JP)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Sumitomo Metal Industries, Ltd

(21) Appl. No.: 12/934,404

(22) PCT Filed: Dec. 15, 2008
(86) PCT No.: PCT/JP2008/072735

§ 371 Date: Nov. 4, 2010

(30) Foreign Application Priority Data
Mar. 31, 2008 (JP) 2008-091071

(51) Int. Cl. B23D 61/02; B26D 3/16; B21B 19/04

(52) U.S. Cl. 83/13; 83/835; 72/97

(57) ABSTRACT

An object of the present invention is to provide a rotary cutting tool, a method of cutting a billet for manufacturing a seamless pipe, and a method of manufacturing the seamless pipe, which are capable of restraining the occurrence of an outer surface flaw on the seamless pipe.

A rotary cutting tool 100 in accordance with the present invention has substantially circular shape and is provided with a plurality of blade parts 1 along the outer peripheral portion thereof. The end face 11 on the downstream side in the direction of rotation of the blade part 1 tilts at an angle θ not smaller than 1 degree and not larger than 10 degrees with respect to the thickness direction Y intersecting at right angles to the direction of rotation X.

### TECHNICAL FIELD

The present invention relates to a rotary cutting tool, a method of cutting a billet for manufacturing a seamless pipe or tube, and a method of manufacturing a seamless pipe or tube. More particularly, it relates to a rotary cutting tool, a method of cutting a billet for manufacturing a seamless pipe or tube, and a method of manufacturing a seamless pipe or tube, which facilitate generation of burrs only on either one of cut billets when a billet for manufacturing a seamless pipe or tube is cut, whereby the occurrence of outer surface flaws on the seamless pipe or tube can be restrained. Hereinafter, “pipe or tube” is referred to as “pipe” when deemed appropriate.

### BACKGROUND ART

In the manufacture of a seamless pipe using the Mannesmann-mandrel mill system, first, a billet, which is a starting material, is heated in a rotary hearth type heating furnace, and then is supplied to a rolling line in sequence. Specifically, a billet is piercing-rolled using a piercer plug and a rolling roll in a piercing-rolling mill to produce a hollow shell. Next, a mandrel bar is inserted into the hollow shell, like an inserted skewer, and the outer surface of the hollow shell is drawn and rolled by a mandrel mill provided with a plurality of rolling stands while being restrained by a grooved roll, whereby the wall thickness of hollow shell is reduced to a predetermined value. Thereafter, the mandrel bar is removed, and the hollow shell whose wall thickness has been reduced is sized by a sizing mill provided with a plurality of rolling stands so as to have a predetermined outside diameter, thereby obtaining a product.

The billet having been heated in the heating furnace is cut to a length according to the product length of seamless pipe before being piercing-rolled by the piercing-rolling mill. To cut the billet, there is used a substantially circular rotary cutting tool provided with a plurality of blade parts along the outer peripheral portion thereof. While this rotary cutting tool is rotated in the circumferential direction, the rotary cutting tool is moved from the direction substantially at right angles to the longitudinal direction of billet toward the billet, whereby the billet is cut in the direction substantially at right angles to the longitudinal direction thereof.

In the center of the end face of each of billets obtained after cutting (hereinafter, the cut billet piece is referred to as a “billet piece” when deemed appropriate to distinguish it from the billet before cutting), a concave is formed by a centering machine. This centering machine has a clamp and a punch and pushes the punch against the center of the end face on one end portion side of billet to form the concave while the outer surface of that one end portion thereof is held by the clamp. On the piercing-rolling mill, the front end of the piercer plug comes into contact with this concave of billet piece, and the billet piece is piercing-rolled.

In this process, on the outer surface of the hollow shell having been piercing-rolled, and in turn, on the outer surface of the seamless pipe, an outer surface flaw such as an eruption of the skin, which is called an outer eruption flaw, may occur. It is desired to restrain the occurrence of this outer surface flaw.

### DISCLOSURE OF THE INVENTION

The present invention has been made in view of the above-described prior art, and accordingly an object thereof is to provide a rotary cutting tool, a method of cutting a billet for manufacturing a seamless pipe, and a method of manufacturing the seamless pipe, which are capable of restraining the occurrence of an outer surface flaw on the seamless pipe.

To solve the above-described problem, the present inventor conducted studies earnestly on the cause of the occurrence of outer surface flaw (outer eruption flaw) on the seamless pipe. As the result, the present inventor found that one cause of the occurrence of outer surface flaw is the burrs occurring in an end portion of the cut billet piece when the billet for manufacturing the seamless pipe is cut in the direction substantially at right angles to the longitudinal direction of the billet. Specifically, it was found that if burrs occur in the end portion on the side on which the concave is formed by the centering machine, the burrs are pressed against the outer surface of billet piece when the concave is formed by the centering machine, and may induce the outer surface flaw.

The present inventor further conducted the studies, and obtained a knowledge described below.

In the conventional rotary cutting tool used for cutting a billet, the end face on the downstream side in the direction of rotation of the blade part (the end face on the side on which the outer surface of billet is cut) is parallel to the thickness direction of rotary cutting tool intersecting at right angles to the direction of rotation. As shown in FIGS. 3A, 3B and 3C, when a billet B is cut in the direction substantially at right angles to the longitudinal direction of billet by using a conventional rotary cutting tool 100′, cutting chips, which are a cause of burrs, may flow in any directions of the thickness direction of rotary cutting tool. That is, in the end portions of both of billet pieces B1 and B2 after cutting, burrs B′ may occur. Therefore, if both the cut billet pieces B1 and B2 on which the burrs B′ have occurred are conveyed in the same direction (the direction indicated by the arrow mark I in FIG. 3B) of the longitudinal direction of billet pieces, and the concave is formed by using the centering machine (as shown in FIG. 3C, having a clamp 20 and a punch 30), for either one billet piece (in the example shown in FIGS. 3A, 3B and 3C, the billet piece B1), the concave is formed in the end face of the end portion on the side on which the burrs if have occurred, so that an outer surface flaw may occur on the billet piece B1, and in turn, on the seamless pipe. Thereupon, it was found that to restrain the occurrence of outer surface flaw, cutting can be performed so as to facilitate generation of burrs only in the end portion of either one of cut billet pieces, and the concave can be provided in the end face of the end portion on the side opposite to the side on which the burrs have occurred.

The present inventor completed the present invention based on the above-described new knowledge.

The present invention provides a rotary cutting tool of substantially circular shape which is provided with a plurality of blade parts along the outer peripheral portion thereof, wherein the end face on the downstream side in the direction of rotation of the blade part tilts at an angle not smaller than 1 degree and not larger than 10 degrees with respect to the thickness direction intersecting at right angles to the direction of rotation.

For the rotary cutting tool in accordance with the present invention, the end face on the downstream side in the direction of rotation of the blade part is not parallel to the thickness direction of rotary cutting tool intersecting at right angles to the direction of rotation, but is tilted. Therefore, if the billet for manufacturing a seamless pipe or tube is cut in the direction substantially at right angles to the longitudinal direction thereof by using the rotary cutting tool in accordance with the present invention, cutting chips, which are a cause of burrs, are liable to flow along the tilt of the end face on the downstream side in the direction of rotation of the blade part. That is, the cutting chips are liable to flow toward the side separating from a face parallel to the thickness direction of the rotary cutting tool. Therefore, generation of burrs is facilitated only in the end portion of a billet piece on the side on which cutting chips are liable to flow (hereinafter, referred to as a “burr-producing billet piece”) of both the cut billet pieces. For this reason, if both the billet pieces are conveyed in the same direction of the longitudinal direction thereof, and a concave is formed by a centering machine so that the concave is provided in the end face of the end portion on the side opposite to the side on which the burrs occur of the burr-producing billet piece, the burrs are not pressed against the outer surfaces of the billet pieces, and the occurrence of outer surface flaw can be restrained. The reason why the lower limit of the relief angle (the angle formed with respect to the thickness direction of rotary cutting tool) of the end face on the downstream side in the direction of rotation of the blade part is set at 1 degree is that if the lower limit thereof is smaller than 1 degrees, like the conventional rotary cutting tool, a possibility that the cutting chips may also flow in any directions of the thickness direction of rotary cutting tool increases. Also, the reason why the upper limit of the relief angle is set at 10 degrees is that if the upper limit thereof exceeds 10 degrees, the interfacial pressure applied to an edge contact part of the blade part increases, and exceeds the mechanical strength of blade part, so that the blade part is liable to be chipped or cracked, which leads to a decrease in service life of rotary cutting tool. In order to allow the cutting chips to flow further easily along the tilt of the end face on the downstream side in the direction of rotation of the blade part, the relief angle of the end face on the downstream side in the direction of rotation of the blade part is preferably set at 3 degrees or larger.

In order to solve the above-described problem, the present invention also provides a method of cutting a billet for manufacturing a seamless pipe or tube, wherein the billet for manufacturing a seamless pipe or tube is cut in the direction substantially at right angles to the longitudinal direction thereof by using the above-described rotary cutting tool.

In order to solve the above-described problem, the present invention further provides a method of manufacturing a seamless pipe or tube, wherein the seamless pipe or tube is manufactured by using a billet for manufacturing a seamless pipe or tube, which is cut by using the above-described cutting method.

According to the present invention, when a billet for manufacturing a seamless pipe or tube is cut, generation of burrs is facilitated only on either one of cut billets, whereby the occurrence of outer surface flaws on the seamless pipe or tube can be restrained.

### BRIEF DESCRIPTION OF THE DRAWINGS

FIGS. 1A, 1B and 1C are schematic views showing a general configuration of a rotary cutting tool in accordance with one embodiment of the present invention, FIG. 1A being a front view showing the whole of the rotary cutting tool, FIG. 1B being an enlarged view of the region A of FIG. 1A, and FIG. 1C being a top view of a blade part as viewed from the direction indicated by the arrow mark C in FIG. 1B;

FIGS. 2A, 2B, 2C and 2D are explanatory views for explaining a method of cutting a billet for manufacturing a seamless pipe by using a rotary cutting tool in accordance with one embodiment of the present invention, FIG. 2A being a side view showing a state in which a cutting operation is started, FIG. 2B being a side view showing a state in which the cutting operation is finished, FIG. 2C being an enlarged front view of the region D of FIG. 2A as viewed from the direction indicated by the arrow mark E in FIG. 2A, and FIG. 2D being an enlarged top view of the region F as viewed from the direction indicated by the arrow mark G in FIG. 2C; and

FIGS. 3A, 3B and 3C are explanatory views for explaining a method of cutting a billet for manufacturing a seamless pipe by using a conventional rotary cutting tool, FIG. 3A being a side view showing a state in which a cutting operation is started, FIG. 3B being a side view showing a state in which the cutting operation is finished, FIG. 3C being a side view showing a state in which a concave is being formed, by using a centering machine, in the end face of the billet having been cut.

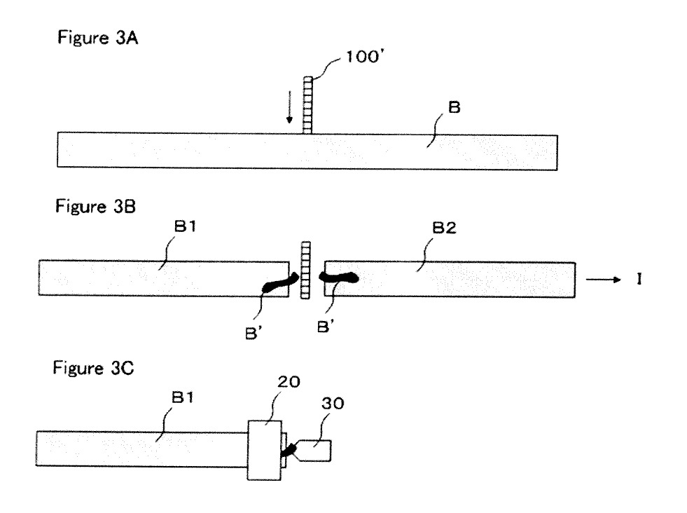

### BEST MODE FOR CARRYING OUT THE INVENTION

One embodiment of a rotary cutting tool in accordance with the present invention and one embodiment of a method of cutting a billet for manufacturing a seamless pipe by using the rotary cutting tool will now be described with reference to the accompanying drawings as appropriate.

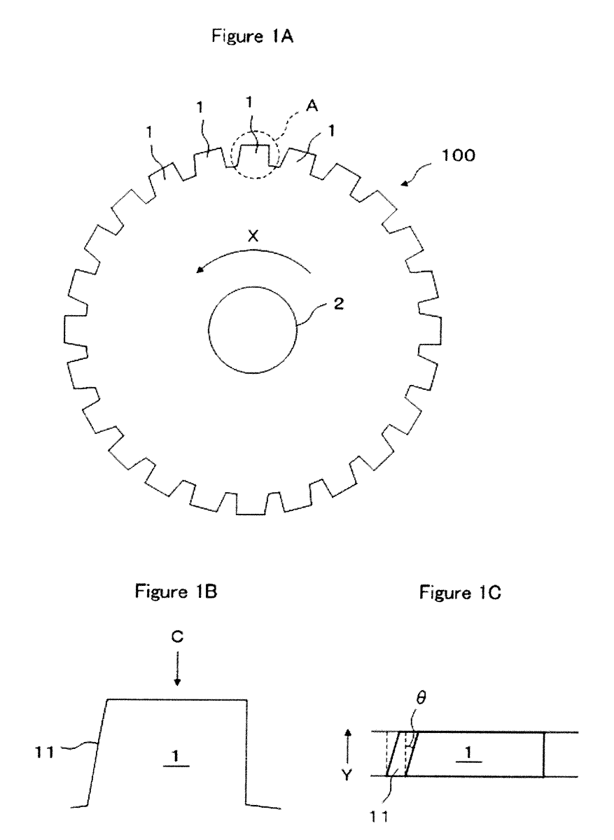

FIGS. 1A, 1B and 1C are schematic views showing a general configuration of a rotary cutting tool in accordance with one embodiment of the present invention, FIG. 1A being a front view showing the whole of the rotary cutting tool, FIG. 1B being an enlarged view of the region A of FIG. 1A, and FIG. 1C being a top view of a blade part as viewed from the direction indicated by the arrow mark C in FIG. 1B.

As shown in FIGS. 1A, 1B and 1C, the rotary cutting tool 100 in accordance with this embodiment is a rotary cutting tool of substantially circular shape which is provided with a plurality of blade parts 1 along the outer peripheral portion thereof, and can be rotated in the circumferential direction. The rotary cutting tool 100 is provided with a shaft hole 2 in the center thereof. The rotary cutting tool 100 is installed to a cutting device (not shown) so as to be rotatable around the center axis via the shaft hole 2.

For the rotary cutting tool 100 in accordance with this embodiment, an end face 11 on the downstream side in the direction of rotation (the direction indicated by the arrow mark X in FIG. 1A) of the blade part 1 tilts at a relief angle θ with respect to the thickness direction (the direction indicated by the arrow mark Y in FIG. 1C) intersecting at right angles to the direction of rotation. This relief angle θ is set at not smaller than 1 degree and not larger than 10 degrees (preferably, not smaller than 3 degrees and not larger than 10 degrees).

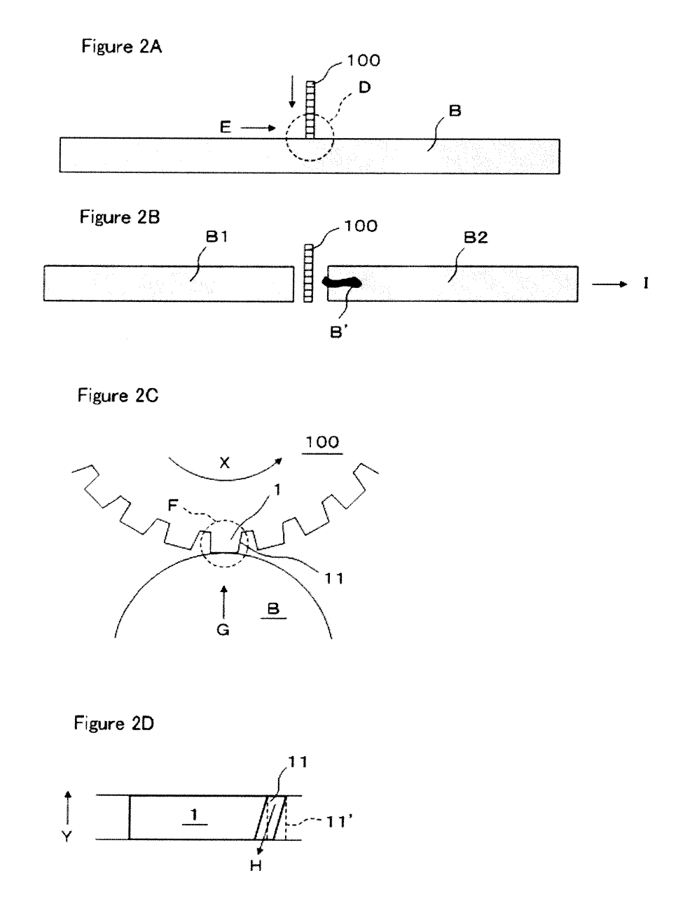

FIGS. 2A, 2B, 2C and 2D are explanatory views for explaining a method of cutting a billet for manufacturing a seamless pipe by using a rotary cutting tool in accordance with one embodiment of the present invention, FIG. 2A being a side view showing a state in which a cutting operation is started, FIG. 2B being a side view showing a state in which the cutting operation is finished, FIG. 2C being an enlarged front view of the region D of FIG. 2A as viewed from the direction indicated by the arrow mark E in FIG. 2A, and FIG. 2D being an enlarged top view of the region F as viewed from the direction indicated by the arrow mark G in FIG. 2C.

As shown in FIGS. 2A, 2B, 2C and 2D, in a state of being rotated, the rotary cutting tool 100 is moved from the direction substantially at right angles to the longitudinal direction of a billet B toward the billet B, whereby the billet B is cut in the direction substantially at right angles to the longitudinal direction thereof, and billet pieces B1 and B2 are formed. At this time, cutting chips, which are a cause of burrs, are liable to flow along the tilt of the end face 11 on the downstream side in the direction of rotation of the blade part 1 of the rotary cutting tool 100. That is, the cutting chips are liable to flow toward the side separating from a face 11′ (the direction indicated by the arrow mark H in FIG. 2D) parallel to the thickness direction of the rotary cutting tool 100 (the direction indicated by the arrow mark Y in FIG. 2D). Therefore, generation of burrs B′ is facilitated only in the end portion of a billet piece on the side on which cutting chips are liable to flow (in the example shown in FIGS. 2A, 2B, 2C and 2D, the billet B2) of both the cut billet pieces B1 and B2. For this reason, if both the billet pieces B1 and B2 are conveyed in the same direction (the direction indicated by the arrow mark I in FIG. 2B) of the longitudinal direction thereof, and a concave is formed by a centering machine so that the concave is provided in the end face of the end portion on the side opposite to the side on which the burrs B′ occur of the billet piece B2, the burrs B′ are not pressed against the outer surfaces of the billet pieces B1 and B2, and the occurrence of outer surface flaw can be restrained.

To the method of manufacturing a seamless pipe by using the billet pieces B1 and B2 having been cut as described above, the conventionally known method can be applied. Therefore, the detailed explanation of the method is omitted herein.

Table 1 gives the result of evaluation of the rate of occurrence of outer eruption flaw (=the number of seamless pipes on which the outer eruption flaw has occurred/the number of seamless pipes being evaluated×100) on the outer surface of a seamless pipe manufactured by using billet pieces cut from a billet made for manufacturing a seamless pipe, which was cut to form the billet pieces by using the rotary cutting tools in accordance with the present invention (examples of θ=1°, 3°, 7° and 10°), the conventional rotary cutting tool (θ=0°), and the rotary cutting tool of comparative example (θ=15°).

TABLE 1

| | Relief | | Rate of occurrence of |
|---|---|---|---|
| | angle θ | Location where burrs occur | outer eruption flaw |
| Comparative example | 0° | Burrs occur on both billet pieces | 4.57% |
| (conventional) | | after cutting | |
| Present invention | 1° | Burrs occur in large amounts on one | 3.56% |
| | | billet piece | |
| Present invention | 3° | Burrs occur only on one billet piece | 0.76% |
| Present invention | 7° | Burrs occur only on one billet piece | 0.72% |
| Present invention | 10° | Burrs occur only on one billet piece | 0.75% |

| | | |
|---|---|---|
| Comparative example | 15° | Not evaluated because blade part was chipped |

As shown in Table 1, it was found that if the rotary cutting tool in accordance with the present invention is used, the occurrence of outer eruption flaw can be restrained as compared with the case where the conventional rotary cutting tool (θ=0°) is used. In particular, in the case where the relief angle was set at not smaller than 3 degrees and not larger than 10 degrees, the occurrence of outer eruption flaw could be restrained significantly.

On the other hand, if the rotary cutting tool in which the relief angle θ was set at 15 degrees was used, the blade part thereof was chipped, so that the cutting test was halted inevitably.

1. A rotary cutting tool of substantially circular shape which is provided with a plurality of blade parts along the outer peripheral portion thereof, wherein
the end face on the downstream side in the direction of rotation of the blade part tilts at an angle not smaller than 1 degree and not larger than 10 degrees with respect to the thickness direction intersecting at right angles to the direction of rotation.

2. A method of cutting a billet for manufacturing a seamless pipe or tube, wherein the billet for manufacturing a seamless pipe or tube is cut in the direction substantially at right angles to the longitudinal direction thereof by using the rotary cutting tool according to claim 1.

3. A method of manufacturing a seamless pipe or tube, wherein the seamless pipe or tube is manufactured by using a billet for manufacturing a seamless pipe or tube, which is cut by using the cutting method according to claim 2.
